(19) United States
(12) Patent Application Publication
(10) Pub. No.: US 2004/0142080 A1
(43) Pub. Date: Jul. 22, 2004

(54) Disposable starch utensil and method of manufacturing the disposable starch utensil

(75) Inventor: Hong-He Lin, Dongguan City (CN)

Correspondence Address: Cooper & Dunham LLP, 1185 Avenue of the Americas, New York, NY, 10036, US

(73) Assignee: Cheng-Hsin Wu

(21) Appl. No.: 10/346,779

(22) Filed: Jan. 17, 2003

(51) Int. Cl. A21D 6/00

(52) U.S. Cl. 426/502

(57) ABSTRACT

A disposable starch utensil in accordance with the present invention is made of a plastic starch mixture having a starch, a polypropene and a builder. A method in accordance with the present invention for manufacturing the disposable starch utensil alternately forms the plastic starch mixture into a granular material and subsequently or directly presses the plastic starch mixture into a sheet and molds any of a variety of disposable utensils. The starch utensil can decompose quickly to prevent environmental pollution. The present invention accommodates both public heath and environment protection issues.

### BACKGROUND OF THE INVENTION

1. Field of the Invention

The present invention relates to a disposable utensil, and more particularly to a disposable starch utensil that is environmentally friendly and a method for manufacturing the disposable starch utensil.

2. Description of Related Art

In a busy industrial and commercial society, most working people eat in restaurants. Many restaurants use disposable utensils to avoid having to wash the utensils and in consideration of public health issues. Moreover, restaurants use disposable utensils to conveniently present food to customers. Conventional disposable utensils are made of styrofoam, plastic or cardboard and constitute large quantities of disposable trash that pollutes the environment. Specifically, used disposable utensils made of styrofoam or plastic damage the environment. The styrofoam and plastic garbage will not decompose so the garbage must be burned. Burning the used styrofoam and plastic utensils produces Dioxin (polychlorinated biphenyls), and Dioxin is a toxic substance that makes people sick.

The government has instituted recycling programs in recent years to reduce the amount of disposable trash and garbage. However, recycling does not solve the styrofoam and plastic disposal problem. The basic method to solve the problem is decreasing the amount of trash and garbage by banning the production of disposable styrofoam and plastic utensils.

Some restaurants use disposable utensils made of cardboard. The disposable cardboard utensils readily decompose in the nature, and burning cardboard will not produce toxic substances. However, the cardboard is made of wood pulp so it is more expensive and must be thick enough to hold the food without leaking. The cardboard wastes natural resources and must be improved.

The present invention has arisen to mitigate or obviate the disadvantages of conventional disposable utensils.

### SUMMARY OF THE INVENTION

The main objective of the present invention is to provide disposable utensils that will decompose quickly without polluting the environmental. The present invention is intended to solve public heath and environmental protection issues.

To achieve the objective, disposable utensils are made of a mixture of a starch, a polypropene and a builder. The mixture is either granular or a sheet and is processed to manufacture a variety of disposable utensils. The material used to make the disposable utensil decomposes quickly, so the present invention is convenient to use and meets the requirements for environmental protection and public health.

Further benefits and advantages of the present invention will become apparent after a careful reading of the detailed description with appropriate reference to the accompanying drawings.

### BRIEF DESCRIPTION OF THE DRAWINGS

FIG. 1 is a block diagram of a method for manufacturing a disposable starch utensil in accordance with the present invention;

FIG. 2 is a product schematic using granular material to produce a disposable starch utensils in accordance with the present invention; and

FIG. 3 is a product schematic using a sheet of material to produce disposable starch utensils in accordance with the present invention.

### DETAILED DESCRIPTION OF THE INVENTION

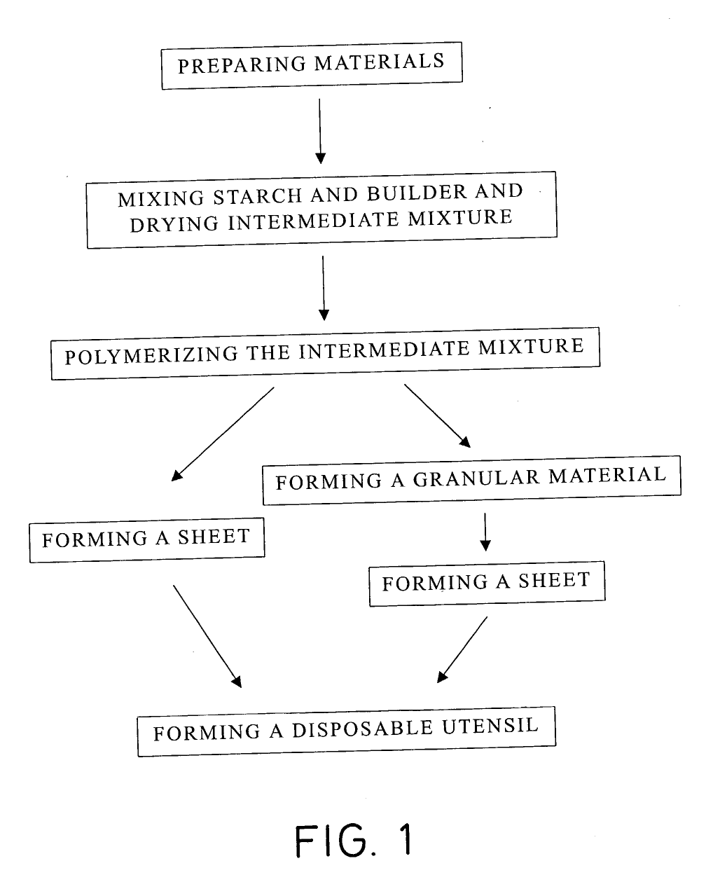

With reference to FIG. 1, a method for manufacturing disposable starch utensils in accordance with the present invention comprises the steps of preparing materials, mixing starch and builder and drying the intermediate mixture, polymerizing the intermediate mixture, forming a sheet and forming a disposable utensil. The materials compose a starch, a plasticizer and a builder according to a formulation ratio. The starch and the builder are mixed at a temperature of 110° C. to 120° C. by a high-speed mixer to form an intermediate mixture. The intermediate mixture is dried at a temperature of 35° C. to 45° C. to control water content to 1%. The intermediate mixture is polymerized by adding the plasticizer and heating to form a plastic starch mixture. The plastic starch mixture has tractility at 120° C. to 210° C. A sheet is formed by pressing the plastic starch mixture. The sheet is heated to 120° C. to 210° C. and molded into a disposable utensil by a high-speed negative pressure forming machine or a high-speed positive pressure thermoforming machine at a temperature of 120° C. to 210° C.

Alternately, the plastic starch mixture may be formed into granular material by a granule-building machine. The granular plastic starch mixture is packaged and is easy to store and transport. A sheet is formed by heating the granular plastic starch mixture so it re-polymerizes and regain plasticity and tractility and pressing the heated granular plastic starch mixture. The sheet is processed and molded into a variety of disposable utensils such as cups, bowls, plates, meal boxes or bags.

The disposable utensil can be sterilized by ultraviolet light to meet public health standards. The sterilized disposable utensil is packaged and sealed to control the quality and make transportation and storage convenient. The manufacturing procedure of the present invention does not use organic solvent, so the procedure does not produce waste water, gas or other material. The present invention is friendly to the environment.

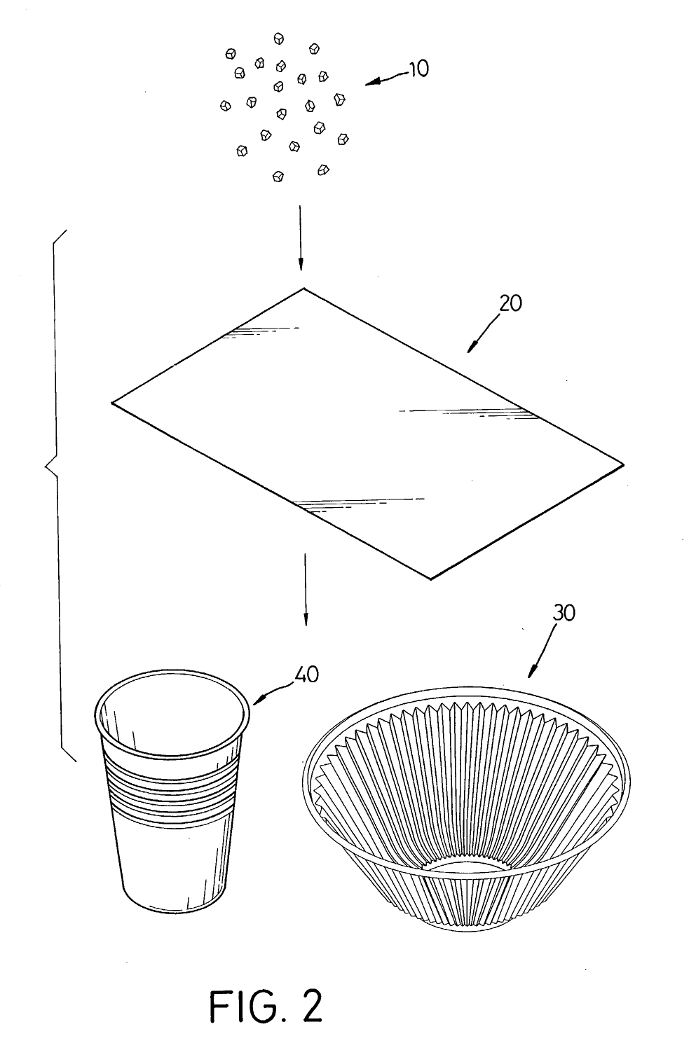

With reference to FIG. 2, a disposable utensil in accordance with the present invention is made of a granular plastic starch material (10) to mold a product. The granular plastic starch material (10) is heated to re-polymerize and regain plasticity and tractility. Then the granular plastic starch material (10) is pressed to form a sheet (20). The sheet (20) is processed and molded into a disposable bowl (30), cup (40) or any of a variety of shapes of disposable utensils. The disposable utensils can be sterilized to meet public health standards.

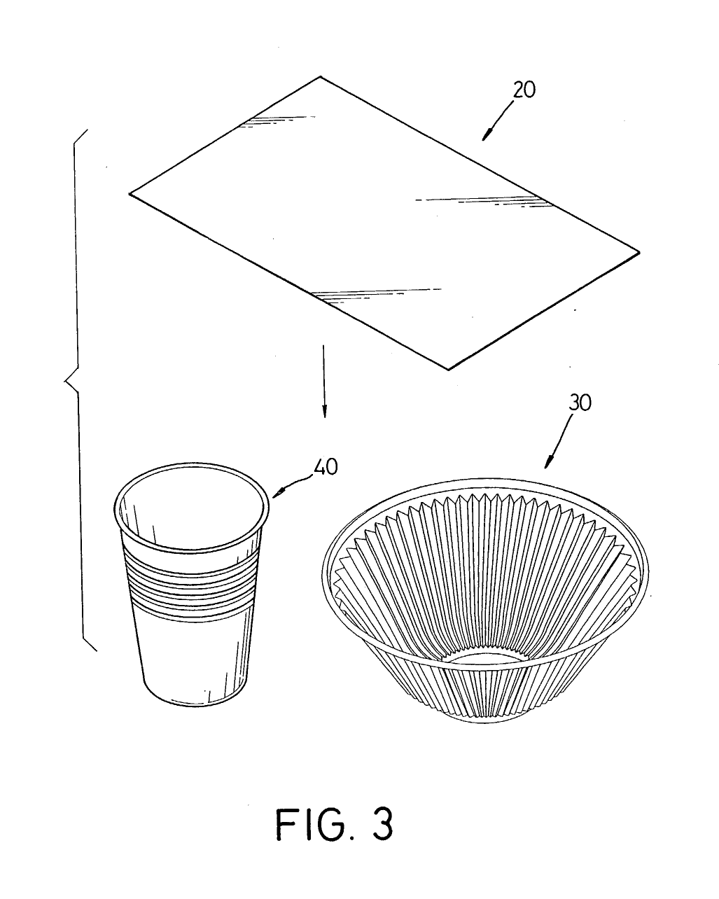

With reference to FIG. 3, a disposable utensil in accordance with the present invention is made of a prepared sheet (20). The prepared sheet (20) is heated to regain plasticity and tractility. The sheet (20) is processed and molded into a disposable bowl (30), cup (40) or any of a variety of shapes of disposable utensils. The disposable utensils can be sterilized to meet public health standards.

The plastic starch mixture is composed of a starch, a plasticizier and a builder. The starch is 50 to 75% of the mixture. The plasticizier contains a polypropene, and the polypropene is 10 to 15% of the mixture. The builder contains a talcum, a sorbitol and a calcium carbonate. The talcum is 5 to 30%, the sorbitol is 5 to 20% and the calcium carbonate is 5 to 15%. The starch is edible, a white granule or powder and is a high molecular weight carbohydrate. The edible starch is obtained from a seed, root or stem of a plant. The plant can be corn, sweet potato, potato, tapioca, rice or wheat in the present invention. The starch is a food and is used in adhesives, textile industry and paper processing. The starch has no flexibility so adding the plasticizer increases the plasticity. The polypropene has flexibility and tolerance to acid, base and heat. The polypropene can be used in sterilized utensils or food package containers. The talcum is a natural inorganic material and can be a builder of an article for daily use. The sorbitol is usually a sugariness in food. The starch mixture is non-toxic and is not dangerous to humans.

The disposable starch utensils will decompose by bacteria into nutrients for plants after two to twelve-months. The disposable starch utensils will not pollute the environment like conventional styrofoam or plastic material. Additionally, the disposable starch utensils are cheaper than conventional disposable utensils made of cardboard.

Although the invention has been explained in relation to its preferred embodiment, it is to be understood that many other possible modifications and variations can be made without departing from the spirit and scope of the invention as hereinafter claimed.

What is claimed is:

1. A disposable starch utensil made of a plastic starch mixture comprising:
an edible starch obtained from a plant, being a white granule and a high molecular weight carbohydrate and comprising 50 to 75% of the mixture;
a plasticizier comprising a polypropene having plasticity and tractility and comprising 10 to 15% of the mixture; and
a builder comprising:
a talcum comprising 5 to 30% of the mixture,
a sorbitol comprising 5 to 20% of the mixture; and
a calcium carbonate comprising 5 to 15% of the mixture.

2. The disposable starch utensil as claimed in claim 1, wherein the edible starch is obtained from at least one of corn, sweet potato, potato, tapioca, rice and wheat.

3. The disposable starch utensil as claimed in claim 1, wherein the disposable starch utensil is a cup.

4. The disposable starch utensil as claimed in claim 1, wherein the disposable starch utensil is a bowl.

5. A method for manufacturing the disposable starch utensil as claimed in claim 1 comprising the following steps:
preparing materials comprising an edible starch, a plasticizer and a builder according to a formulation ratio;
mixing the edible starch and the builder to form an intermediate mixture at a temperature of 110° C. to 120° C. by a high-speed mixer and drying the intermediate mixture at 35° C. to 45° C. to control water content to 1%;
polymerizing the intermediate mixture by adding the plasticizer and heating to form a plastic starch mixture;
forming a sheet by pressing the plastic starch mixture; and
forming a disposable utensil by heating the sheet to 120° C. to 210° C. and molding the heated sheet into a disposable utensil by a high-speed negative pressure forming machine or a high-speed positive pressure thermoforming machine at a temperature of 120° C. to 210° C.

6. A method for manufacturing the disposable starch utensil as claimed in claim 1 comprising the following steps:
preparing materials comprising an edible starch, a plasticizer and a builder according to a formulation ratio;
mixing the edible starch and the builder to form an intermediate mixture at a temperature of 11° C. to 120° C. by a high-speed mixer and drying the intermediate mixture at 35° C. to 45° C. to control water content 1%;
polymerizing the intermediate mixture by adding the plasticizer and heating to form a plastic starch mixture;
forming a granular plastic starch mixture by a granule-building machine and
forming the granular plastic starch mixture into sheets by heating the granular plastic starch mixture to re-polymerize and regain plasticity and tractility and pressing the plastic starch mixture to form sheets; and
forming a disposable utensil by heating the sheet to 120° C. to 210C and molding the heated sheet into a disposable utensil by a high-speed negative pressure forming machine or a high-speed positive pressure thermoforming machine at a temperature of 120° C. to 210° C.
